(19) United States
(12) Patent Application Publication
(10) Pub. No.: US 2026/0222070 A1
(43) Pub. Date: Jul. 30, 2026

(54) ELECTRO-OPTICAL DEVICE WITH HYBRID PHOTONIC PLATFORM

(71) Applicant: Cisco Technology, Inc., San Jose, CA (US)

(72) Inventors: Norbert SCHLEPPLE, Macungie, PA (US); Prakash B. GOTHOSKAR, Allentown, PA (US); Kadaba LAKSHMIKUMAR, Hillsborough, NJ (US)

(21) Appl. No.: 19/036,807

(22) Filed: Jan. 24, 2025

(51) Int. Cl. H04B 10/40; H04B 10/80

(52) U.S. Cl. CPC H04B 10/40; H04B 10/80

(57) ABSTRACT

An electro-optical device is provided. The electro-optical device has an electronic integrated circuit (EIC) having a trans-impedance amplifier (TIA) and a driver. The electro-optical device also includes a hybrid photonic integrated circuit (PIC) having a receiver circuit and a transmitter circuit both coupled with the EIC. The receiver circuit has a surface-illuminated photodiode arranged to directly receive incoming optical signals and to convert the incoming optical signals to electrical signals, with the electrical signals being routed to the TIA. The transmitter circuit has a modulator and a grating coupler. The modulator is arranged to convert electrical signals received from the driver to outgoing optical signals, with the outgoing optical signals being routed to the grating coupler for transmission of the outgoing optical signals.

### TECHNICAL FIELD

Embodiments presented in this disclosure generally relate to electro-optical devices, such as optical transceivers for networking applications.

### BACKGROUND

Some optical transceivers include integrated receiver and transmitter circuits on a photonic integrated circuit (PIC). At least some integrated receiver circuits can have associated optical losses as a result of PIC coupling inefficiencies and on-chip routing. This can limit receiver sensitivity and signal-to-noise ratio (SNR) performance at low signal inputs. Moreover, random signal polarization and power fluctuations can necessitate on-chip optical signal conditioning (dynamic polarization power monitoring/balancing) using fast sense/control circuits. Solutions for non-integrated receiver circuits have been contemplated, but such solutions have led to complicated fiber array unit (FAU) attachments and optical alignment processes during fabrication.

### BRIEF DESCRIPTION OF THE DRAWINGS

So that the manner in which the above-recited features of the present disclosure can be understood in detail, a more particular description of the disclosure, briefly summarized above, may be had by reference to embodiments, some of which are illustrated in the appended drawings. It is to be noted, however, that the appended drawings illustrate typical embodiments and are therefore not to be considered limiting; other equally effective embodiments are contemplated.

FIG. 1 is a schematic top plan view of an electro-optical device according to one or more aspects of the present disclosure.

FIGS. 2A and 2B provide schematic views of an electro-optical device according to one or more aspects of the present disclosure.

FIG. 3 is a schematic top plan view of an electro-optical device according to one or more aspects of the present disclosure.

FIG. 4 is a schematic side view of an electro-optical device according to one or more aspects of the present disclosure.

FIG. 5 is a close-up cross-sectional view of a hybrid photonic integrated circuit (PIC) having a reflective layer arranged relative to surface-illuminated photodiode according to one or more aspects of the present disclosure.

FIG. 6 is a close-up cross-sectional view of a hybrid photonic integrated circuit (PIC) having a diffractive element arranged relative to surface-illuminated photodiode according to one or more aspects of the present disclosure.

FIG. 7 is a schematic side cross-sectional view of an electro-optical device according to one or more aspects of the present disclosure.

FIG. 8 is a schematic side cross-sectional view of an electro-optical device according to one or more aspects of the present disclosure.

FIG. 9 provides a flow diagram for a method of fabricating an electro-optical device according to one or more aspects of the present disclosure.

FIG. 10 provides a flow diagram for a method of fabricating an electro-optical device according to one or more aspects of the present disclosure.

FIG. 11 provides a flow diagram for a method of fabricating an electro-optical device according to one or more aspects of the present disclosure.

To facilitate understanding, identical reference numerals have been used, where possible, to designate identical elements that are common to the figures. It is contemplated that elements disclosed in one embodiment may be beneficially used in other embodiments without specific recitation.

### DESCRIPTION OF EXAMPLE EMBODIMENTS

### Overview

In one aspect, an electro-optical device is provided. The electro-optical device includes an electronic integrated circuit (EIC) having a trans-impedance amplifier (TIA) and a driver. The electro-optical device also includes a hybrid photonic integrated circuit (PIC) having a receiver circuit and a transmitter circuit both coupled with the EIC. The receiver circuit has a surface-illuminated photodiode arranged to directly receive incoming optical signals and to convert the incoming optical signals to electrical signals, with the electrical signals being routed to the TIA. The transmitter circuit has a modulator and a grating coupler. The modulator is arranged to convert electrical signals received from the driver to outgoing optical signals, with the outgoing optical signals being routed to the grating coupler for transmission of the outgoing optical signals.

In a further aspect, an electro-optical device is provided. The electro-optical device includes a fiber array unit having a receiver fiber and a transmitter fiber. The electro-optical device also includes a hybrid photonic integrated circuit (PIC) having a receiver circuit and a transmitter circuit. The receiver circuit has a surface-illuminated photodiode arranged to directly receive incoming optical signals from the receiver fiber and to convert the incoming optical signals to electrical signals. The transmitter circuit has a modulator and a grating coupler. The modulator is arranged to convert electrical signals received from an electronic integrated circuit to outgoing optical signals, with the outgoing optical signals being routed to the grating coupler for transmission of the outgoing optical signals to the transmitter fiber. The receiver fiber and the transmitter fiber are arranged to concurrently optically couple with the surface-illuminated photodiode and the grating coupler, respectively.

In yet a further aspect, a method of fabricating an electro-optical device is provided. The method includes coupling an electronic integrated circuit (EIC) to a hybrid photonic integrated circuit (PIC) wafer, the hybrid PIC wafer having a surface-illuminated photodiode embedded therein, or bonded or flip-chip attached thereto, wherein an electrical trace electrically couples the surface-illuminated photodiode with the EIC. The method further includes singulating the hybrid PIC wafer to form singulated units, with at least one of the singulated units having the EIC and a hybrid PIC, which is a portion of the hybrid PIC wafer that includes the surface-illuminated photodiode. The method also includes attaching a fiber array unit (FAU) to the hybrid PIC so that an optical fiber of the FAU is optically coupled with the surface-illuminated photodiode. The surface-illuminated photodiode is arranged to directly receive incoming optical signals from the optical fiber and to convert the incoming optical signals to electrical signals, with the electrical trace being arranged to route the electrical signals to the EIC.

### Example Embodiments

Some optical transceivers can include integrated receiver and transmitter circuits on a photonic integrated circuit (PIC). Such integrated receiver circuits can have associated optical losses as a result of PIC coupling inefficiencies and on-chip routing and conditioning of optical signals. Non-integrated receiver circuits have been contemplated, but such solutions have led to less than desirable fiber array unit (FAU) attachments and challenging optical alignment processes during fabrication. Embodiments disclosed herein provide electro-optical devices with hybrid photonic platforms that can address one or more of these noted challenges. Methods of fabricating such electro-optical devices are also provided.

In one example, an electro-optical device is provided. The electro-optical device can be an optical transceiver for a networking application, for example. The electro-optical device can include an electronic integrated circuit (EIC) having a trans-impedance amplifier (TIA) and a driver. The electro-optical device can also include a hybrid PIC, or hybrid photonic platform, having a receiver circuit and a transmitter circuit both electrically coupled with the EIC. The receiver circuit has a surface-illuminated photodiode arranged to directly receive incoming optical signals and to convert the incoming optical signals to electrical signals, with the electrical signals being routed to the TIA of the EIC. The incoming optical signals can be received by the surface-illuminated photodiode from an optical fiber of an FAU, for example. The transmitter circuit has a modulator and a grating coupler. The modulator is arranged to convert electrical signals received from the driver to outgoing optical signals, with the outgoing optical signals being routed to the grating coupler for transmission of the outgoing optical signals, e.g., to an optical fiber of the FAU.

The hybrid PIC of the electro-optical device is deemed a “hybrid” PIC in the sense that the receiver circuit is an electrically-enabled circuit (or primarily electrically-enabled) while the transmitter circuit is both electrically-and optically-enabled. The surface-illuminated photodiode of the receiver circuit immediately converts incoming optical signals into electrical signals, which are routed to the TIA of the EIC. In this regard, incoming signals travel through the chip of the hybrid PIC in electrical form. In contrast, the transmitter circuit can include a transmitter electrical trace that enables routing of outgoing electrical signals from the driver of the EIC to the modulator, which converts the electrical signals to outgoing optical signals. The outgoing optical signals can be routed to the grating coupler by way of an optical waveguide of the hybrid PIC. The grating coupler can facilitate transmission of the outgoing optical signals. In this way, outgoing signals travel through the chip of the hybrid PIC in both electrical and optical form.

The architecture of the electro-optical device can provide certain advantages, benefits, and/or technical effects. For instance, the transmitter circuit can be fully integrated on-chip of the hybrid PIC, which can provide high levels of signal integrity (SI) on the transmitter side. Further, on the receiver side of the hybrid PIC, the receiver signal input can be polarization insensitive such that reduced or no polarization splitting functionality is needed on the FAU, the hybrid PIC, or other upstream device, which can enable easier control on the receiver side. For instance, splitting transverse electric (TE) and transverse magnetic (TM) modes of optical signals can be eliminated or reduced. Moreover, improved receiver sensitivity can be achieved, namely because (i) coupling losses, e.g., from an optical fiber to the hybrid PIC, can be eliminated or significantly reduced due at least in part to the lack of grating coupler on the receiver circuit; and (ii) on-chip losses can be reduced or significantly reduced due at least in part to the lack of propagation, sensing, and variable optical attenuators (VOAs) in the receiver circuit. In addition, dynamic range control (overall power, polarization balancing), which has conventionally been handled by VOAs in the receiver circuit, can be eliminated or significantly reduced. Also, the architecture of the receiver circuit can enable the use of an annular surface-illuminated photodiode, which can further increase sensitivity.

Furthermore, in one or more examples, the surface-illuminated photodiode and the grating coupler can be arranged on the hybrid PIC so that the optical fiber associated with the receiver circuit and the optical fiber associated with the transmitter circuit are arranged to concurrently optically couple with the surface-illuminated photodiode and the grating coupler, respectively. Accordingly, concurrent optical coupling can be achieved with a single FAU to the grating coupler and the surface-illuminated photodiode. The surface-illuminated photodiode can also relax accuracy requirements with respect to alignment of an optical fiber thereto. Thus, optical alignment of the optical elements can be achieved with enhanced accuracy, repeatability, and speed. The electro-optical devices having hybrid photonic platforms as disclosed herein can have other advantages, benefits, and/or technical effects than those expressly noted herein.

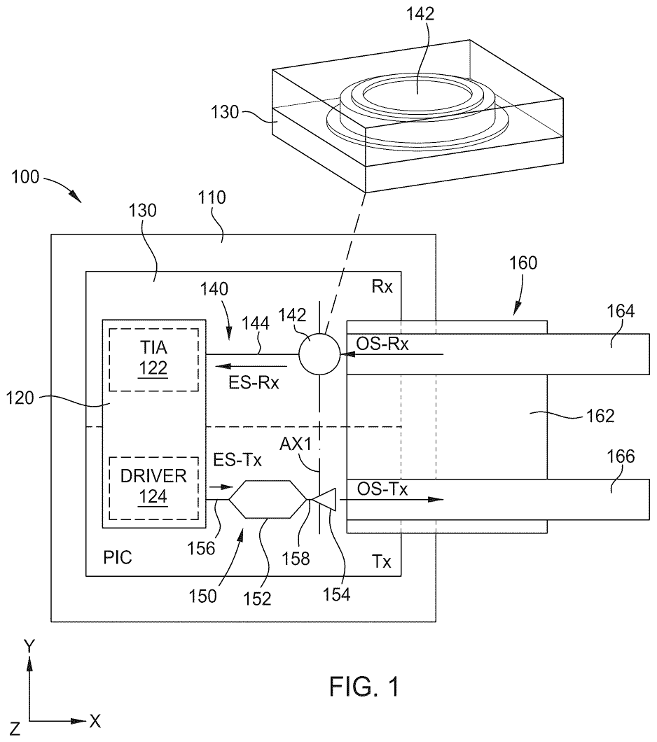

Turning now to the drawings, FIG. 1 provides a schematic top view of an electro-optical device 100 according to one or more aspects of the present disclosure. The electro-optical device 100 can be used in optical transceiver applications, among others. For reference, the electro-optical device 100 defines an X-direction, a Y-direction, and a Z-direction, which are mutually perpendicular to one another. The X-direction can be a longitudinal direction, the Y-direction can be a lateral direction, and the Z-direction can be a vertical direction, for example.

As depicted in FIG. 1, the electro-optical device 100 includes a substrate 110 (e.g., a printed circuit board (PCB)), an electrical integrated circuit (EIC), or EIC 120, a hybrid photonic integrated circuit (PIC), or hybrid PIC 130, and a fiber array unit, or FAU 160. The hybrid PIC 130, which can be formed as a silicon on insulator (SOI) chip, can be bonded or otherwise attached to the substrate 110, and the EIC 120 can be bonded or otherwise attached to the hybrid PIC 130. In this regard, the EIC 120 can be stacked on the hybrid PIC 130, and the hybrid PIC 130 can be stacked on the substrate 110. The EIC 120 has a trans-impedance amplifier (TIA), or TIA 122, and a driver 124. In depicted embodiment of FIG. 1, the TIA 122 and the driver 124 of the EIC 120 are formed on a single chip, and this single chip is flip-chip attached to the hybrid PIC 130. The TIA 122 can be associated with a receiver side of an optical transceiver and the driver 124 can be associated with a transmitter side of the optical transceiver. In at least one example, the EIC 120 can be an application-specific integrated circuit (ASIC), e.g., for networking applications. The FAU 160 has a holder 162 that holds and supports optical fibers, including, for example, a first optical fiber 164 and a second optical fiber 166. The optical fibers 164, 166 can each be single mode fibers (SMF), for example.

The hybrid PIC 130 has a receiver circuit 140 and a transmitter circuit 150 both coupled with the EIC 120. The receiver circuit 140 is coupled with the TIA 122 of the EIC 120 while the transmitter circuit 150 is coupled with the driver 124 of the EIC 120. The receiver circuit 140 has a surface-illuminated photodiode 142 arranged to directly receive incoming optical signals OS-Rx (e.g., from the first optical fiber 164) and to convert the incoming optical signals OS-Rx to electrical signals ES-Rx, with the electrical signals ES-Rx being routed to the TIA 122 by way of a receiver electrical trace 144 of the receiver circuit 140. In one or more examples, the electrical signals ES-Rx output by the surface-illuminated photodiode 142 can be routed from the surface-illuminated photodiode 142 directly to the EIC 120 along the receiver electrical trace 144 (i.e., without passing through any intermediate components arranged along the receiver circuit 140). As shown in the close-up in FIG. 1, the surface-illuminated photodiode 142 can be an annular surface-illuminated photodiode. The surface-illuminated photodiode 142 can be embedded within the chip of the hybrid PIC 130 as shown in FIG. 1. Alternatively, as will be described later in the disclosure, the surface-illuminated photodiode 142 can be mounted to a surface (e.g., a top surface) of the chip of the hybrid PIC 130.

The architecture of the receiver circuit 140 can provide certain advantages, benefits, and/or technical effects. For instance, the receiver signal input can become polarization insensitive such that reduced or no polarization splitting functionality is needed on the FAU 160, the hybrid PIC 130, or other upstream device, which can enable easier control. Moreover, improved receiver sensitivity can be achieved, namely because (i) coupling losses, e.g., from the first optical fiber 164 to the hybrid PIC 130, can be eliminated or significantly reduced due at least in part to the lack of grating coupler on the receiver circuit 140; and (ii) on-chip losses can be reduced or significantly reduced due at least in part to the lack of propagation, sensing, and variable optical attenuators in the receiver circuit 140. In addition, dynamic range control (overall power, polarization balancing), which has conventionally been handled by variable optical attenuators in the receiver circuit 140, can be eliminated or significantly reduced. Also, the architecture of the receiver circuit 140 can enable the use of an annular surface-illuminated photodiode, which can further increase sensitivity.

The transmitter circuit 150 of the hybrid PIC 130 has a modulator 152 and a grating coupler 154. The modulator 152 is arranged to convert electrical signals ES-Tx received from the driver 124 to outgoing optical signals OS-Tx. The electrical signals ES-Tx can be routed to the modulator 152 by way of a transmitter electrical trace 156. The outgoing optical signals OS-Tx can be routed from the modulator 152 to the grating coupler 154 by way of an optical waveguide 158 of the transmitter circuit 150. The grating coupler 154 can facilitate transmission of the outgoing optical signals OS-Tx, e.g., to the second optical fiber 166.

In one or more examples, the surface-illuminated photodiode 142 and the grating coupler 154 can be arranged on the hybrid PIC 130 so that the first optical fiber 164 and the second optical fiber 166 of the FAU 160 are arranged to concurrently optically couple with the surface-illuminated photodiode 142 and the grating coupler 154, respectively. In such examples, the surface-illuminated photodiode 142 and the grating coupler 154 can be coplanarly arranged on the hybrid PIC 130, e.g., along an axis AX1. Such features can enable a single FAU attachment.

The hybrid PIC 130 is designated herein as a “hybrid” PIC in the sense that the receiver circuit 140 is an electrically-enabled circuit (or primarily electrically-enabled) while the transmitter circuit 150 is both electrically and optically enabled. As noted above, the receiver circuit 140 includes the surface-illuminated photodiode 142 that immediately converts incoming optical signals OS-Rx into electrical signals ES-Rx, which are routed to the EIC 120. In this regard, incoming signals travel through the chip of the hybrid PIC 130 in electrical form. In contrast, the transmitter circuit 150 includes the transmitter electrical trace 156 that enables routing of the outgoing electrical signals ES-Tx to the modulator 152, which converts the electrical signals ES-Tx to outgoing optical signals OS-Tx. The outgoing optical signals OS-Tx are routed to the grating coupler 154 by way of the optical waveguide 158. The grating coupler 154 can facilitate transmission of the outgoing optical signals OS-Tx. In this way, outgoing signals travel through the chip of the hybrid PIC 130 in both electrical and optical form. Accordingly, the receiver circuit 140 can have the associated advantages, benefits, and/or technical effects noted above, while the transmitter circuit 150 can advantageously achieve co-integration with the driver 124, channel density, and can maintain the control circuits. Moreover, a single FAU attachment can be achieved accurately and in a repeatable manner with the hybrid architecture, e.g., with the second optical fiber 166 being aligned with the grating coupler 154, while the surface-illuminated photodiode 142 enables relaxed accuracy requirements with respect to alignment of the first optical fiber 164 thereto.

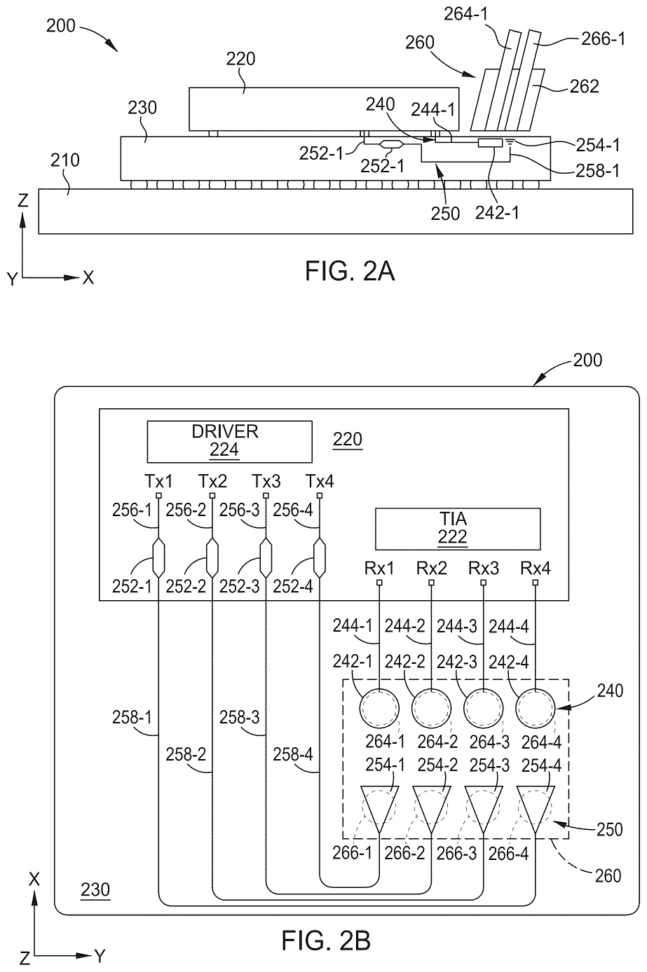

FIGS. 2A and 2B provide schematic views of an electro-optical device 200 according to one or more aspects of the present disclosure. FIG. 2A is a schematic cross-sectional view of the electro-optical device 200 and FIG. 2B is a schematic top view of the electro-optical device 200. As will be explained further below, the electro-optical device 200 includes a hybrid PIC (having a hybrid architecture much like the hybrid PIC 130 of the electro-optical device 100 of FIG. 1). The hybrid PIC of the electro-optical device 200 has surface-illuminated photodiodes and grating couplers arranged so as to minimize the receiver electrical trace lengths from the surface-illuminated photodiodes to an EIC. In addition, the electro-optical device 200 can include an FAU having optical fibers arranged complementary to the surface-illuminated photodiodes and grating couplers. An example is provided below.

As depicted in FIGS. 2A and 2B, the electro-optical device 200 includes a substrate 210 (e.g., a PCB; shown in FIG. 2A), an EIC 220, a hybrid PIC 230, and an FAU 260. The hybrid PIC 230 can be bonded or otherwise attached to the substrate 210, and the EIC 220 can be bonded or otherwise attached to the hybrid PIC 230. In this regard, the EIC 220 can be stacked on the hybrid PIC 230, and the hybrid PIC 230 can be stacked on the substrate 210, e.g., as shown in FIG. 2A. The EIC 220 has a TIA 222 and a driver 224, which can be located on a single chip. In at least one example, the EIC 220 can be an ASIC, e.g., for networking applications.

As depicted in FIG. 2B, for this example, the electro-optical device 200 has eight (8) channels, with a receiver circuit 240 of the hybrid PIC 230 having four (4) receiver channels Rx1, Rx2, Rx3, Rx4 and a transmitter circuit 250 of the hybrid PIC 230 having four (4) transmitter channels Tx1, Tx2, Tx3, Tx4. In other examples, the electro-optical device 200 can have more or less than eight (8) channels. The receiver channels Rx1, Rx2, Rx3, Rx4 each have surface-illuminated photodiodes 242-1, 242-2, 242-3, 242-4 and associated receiver electrical traces 244-1, 244-2, 244-3, 244-4 that electrically couple their respective surface-illuminated photodiodes 242-1, 242-2, 242-3, 242-4 to the TIA 222 of the EIC 220. Each of the transmitter channels Tx1, Tx2, Tx3, Tx4 have modulators 252-1, 252-2, 252-3, 252-4 optically coupled with grating couplers 254-1, 254-2, 254-3, 254-4 by way of respective optical waveguides 258-1, 258-2, 258-3, 258-4. Transmitter electrical traces 256-1, 256-2, 256-3, 256-4 enable routing of electrical signals between the driver 224 of the EIC 220 and the modulators 252-1, 252-2, 252-3, 252-4.

In this example, the surface-illuminated photodiodes 242-1, 242-2, 242-3, 242-4 and the grating couplers 254-1, 254-2, 254-3, 254-4 are arranged so as to prioritize electrical receiver signal routing, e.g., by minimizing the lengths of the receiver electrical traces 244-1, 244-2, 244-3, 244-4. As illustrated in FIG. 2B, the surface-illuminated photodiodes 242-1, 242-2, 242-3, 242-4 are arranged closer to the EIC 220 than the grating couplers 254-1, 254-2, 254-3, 254-4, e.g., along the X-direction. Specifically, the surface-illuminated photodiodes 242-1, 242-2, 242-3, 242-4 are arranged in a first row and the grating couplers 254-1, 254-2, 254-3, 254-4 are arranged in a second row that is further from the EIC 220 than the first row, e.g., along the X-direction. The receiver electrical traces 244-1, 244-2, 244-3, 244-4 can each extend directly to the EIC 220, e.g., without any lateral turns along the Y-direction, which minimizes their respective lengths and consequently reduces electrical signal losses along the receiver channels Rx1, Rx2, Rx3, Rx4.

In one or more examples, such as in the depicted example of FIG. 2B, the grating couplers 254-1, 254-2, 254-3, 254-4 can be arranged closer to the TIA 222 than the driver 224, and the optical waveguides 258-1, 258-2, 258-3, 258-4 can each extend, at least in part, along the Y-direction (or a direction parallel to the long axes of the receiver electrical traces 244-1, 244-2, 244-3, 244-4). The optical waveguides 258-1, 258-2, 258-3, 258-4 can each be longer than the receiver electrical traces 244-1, 244-2, 244-3, 244-4. In some examples, the optical waveguides 258-1, 258-2, 258-3, 258-4 can initially extend away from the EIC 220 before traveling laterally, e.g., along the Y-direction, and then ultimately toward the EIC 220, e.g., along the X-direction. Accordingly, in one or more examples, the distances of the receiver channels Rx1, Rx2, Rx3, Rx4 from the surface-illuminated photodiodes 242-1, 242-2, 242-3, 242-4 to the EIC 220 are each less than the distances of the transmitter channels Tx1, Tx2, Tx3, Tx4 from the grating couplers 254-1, 254-2, 254-3, 254-4 to the EIC 220. In this regard, the receiver channels Rx1, Rx2, Rx3, Rx4 are prioritized and shorter in length than the transmitter channels Tx1, Tx2, Tx3, Tx4.

The FAU 260 (depicted in dashed lines in FIG. 2B) has a holder 262 that holds and supports a plurality of optical fibers that are surface mounted to a top surface of the hybrid PIC 230. The optical fibers held by the holder 262 are generally arranged complementary to the arrangement of the surface-illuminated photodiodes 242-1, 242-2, 242-3, 242-4 and the grating couplers 254-1, 254-2, 254-3, 254-4. The optical fibers of the FAU 260 include receiver optical fibers 264-1, 264-2, 264-3, 264-4 arranged to optically couple with the surface-illuminated photodiodes 242-1, 242-2, 242-3, 242-4. The surface-illuminated photodiodes 242-1, 242-2, 242-3, 242-4 each provide a coupling interface for receiving incoming optical signals from their respective receiver optical fibers 264-1, 264-2, 264-3, 264-4. Each one of the receiver channels Rx1, Rx2, Rx3, Rx4 has a single coupling interface for receiving incoming optical signals. The FAU 260 also includes transmitter optical fibers 266-1, 266-2, 266-3, 266-4 arranged to optically couple with the grating couplers 254-1, 254-2, 254-3, 254-4. The receiver optical fibers 264-1, 264-2, 264-3, 264-4 and the transmitter optical fibers 266-1, 266-2, 266-3, 266-4 are shown in dashed lines in FIG. 2B, and can each be SMFs, for example. The receiver optical fibers 264-1, 264-2, 264-3, 264-4 are arranged in a first row and the transmitter optical fibers 266-1, 266-2, 266-3, 266-4 are arranged in a second row, wherein the first and second rows of optical fibers of the FAU 260 are arranged complementary to the first and second rows of the surface-illuminated photodiodes 242-1, 242-2, 242-3, 242-4 and the grating couplers 254-1, 254-2, 254-3, 254-4.

For the receiver channels Rx1, Rx2, Rx3, Rx4 of the receiver circuit 240, the surface-illuminated photodiodes 242-1, 242-2, 242-3, 242-4 are each arranged to directly receive incoming optical signals from their respective receiver optical fibers 264-1, 264-2, 264-3, 264-4 and to convert the incoming optical signals to electrical signals, with the electrical signals being routed to the TIA 222 along their respective receiver electrical traces 244-1, 244-2, 244-3, 244-4. For the transmitter channels Tx1, Tx2, Tx3, Tx4 of the transmitter circuit 250, the modulators 252-1, 252-2, 252-3, 252-4 are arranged to convert electrical signals received from the driver 224 to outgoing optical signals, the outgoing optical signals can be routed from the modulators 252-1, 252-2, 252-3, 252-4 to the grating couplers 254-1, 254-2, 254-3, 254-4 by way of the optical waveguides 258-1, 258-2, 258-3, 258-4 for transmission of the outgoing optical signals to the transmitter optical fibers 266-1, 266-2, 266-3, 266-4.

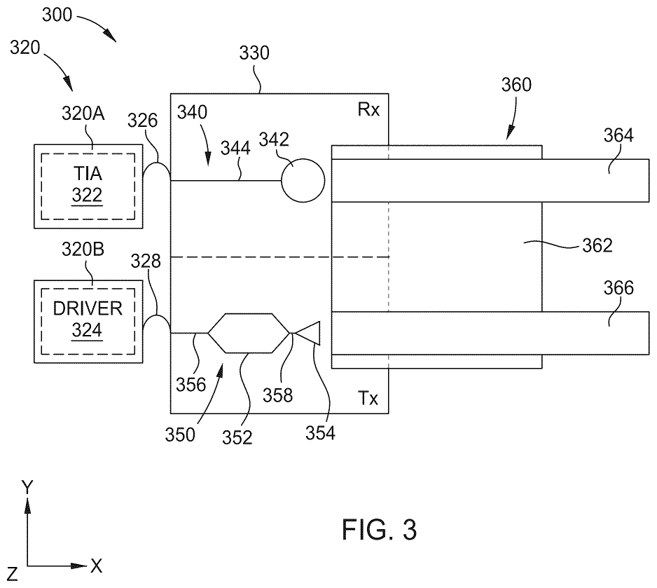

FIG. 3 is a schematic top plan view of an electro-optical device 300 according to one or more aspects of the present disclosure. As will be explained further below, the electro-optical device 300 includes an EIC having a TIA and a driver arranged on separate chips that are arranged relative to a hybrid PIC (having a hybrid architecture much like the hybrid PIC 130 of the electro-optical device 100 of FIG. 1) and connected thereto, e.g., wirebonds. An example is provided below.

As depicted in FIG. 3, the electro-optical device 300 includes an EIC 320, a hybrid PIC 330, and an FAU 360. The electro-optical device 300 can also include a substrate (e.g., a PCB), which is not shown in FIG. 3. The EIC 320 has a TIA 322 and a driver 324 formed on separate first and second chips 320A, 320B, or rather, a receiver chip and a transmitter chip. The first and second chips 320A, 320B are spaced from one another, e.g., along the Y-direction, and are coplanarly arranged and placed next to the hybrid PIC 330, e.g., along the X-direction. In at least one example, the EIC 320 can be an ASIC, e.g., for networking applications.

The hybrid PIC 330 is constructed in a similar manner as the hybrid PIC 130 of the electro-optical device 100 of FIG. 1. The hybrid PIC 330 includes a receiver circuit 340 having a surface-illuminated photodiode 342 and a receiver electrical trace 344. The surface-illuminated photodiode 342 and the receiver electrical trace 344 collectively form a receiver channel of the hybrid PIC 330. While only one receiver channel is depicted in FIG. 3, in other examples, the receiver circuit 340 can include a plurality of receiver channels each having a surface-illuminated photodiode and associated receiver electrical trace. The surface-illuminated photodiode 342 is arranged to directly receive incoming optical signals from a receiver optical fiber 364 of the FAU 360 and to convert the incoming optical signals to electrical signals, with the electrical signals being routed to the TIA 322 by way of the receiver electrical trace 344 and a wirebond 326 that electrically couples the receiver electrical trace 344 with the first chip 320A, or more specifically, the TIA 322. In this regard, the first chip 320A having the TIA 322 is wire bonded to the receiver electrical trace 344, which is electrically coupled with the surface-illuminated photodiode 342.

A transmitter circuit 350 of the hybrid PIC 330 has a modulator 352, a grating coupler 354, a transmitter electrical trace 356, and an optical waveguide 358. The modulator 352, the grating coupler 354, the transmitter electrical trace 356, and the optical waveguide 358 collectively form a transmitter channel of the hybrid PIC 330. While only one transmitter channel is depicted in FIG. 3, in other examples, the transmitter circuit 350 can include a plurality of transmitter channels each having the noted elements. In the example of FIG. 3, the surface-illuminated photodiode 342, the grating coupler 354, and the modulator 352 are all arranged on a single chip of the hybrid PIC 330.

The driver 324 of the second chip 320B is wire bonded to the hybrid PIC 330, or more particularly, to the transmitter electrical trace 356, which is electrically coupled with the modulator 352. A wirebond 328 electrically couples the transmitter electrical trace 356 with the second chip 320B, or more specifically, the driver 324. In this way, electrical signals output by the driver 324 can be routed to the modulator 352 by way of the wirebond 328 and the transmitter electrical trace 356, and the modulator 352 can convert the electrical signals to outgoing optical signals, the outgoing optical signals can be routed from the modulator 352 to the grating coupler 354 by way of the optical waveguide 358 for transmission of the outgoing optical signals to a transmitter optical fiber 366 of the FAU 360. The receiver optical fiber 364 and the transmitter optical fiber 366 are held by a holder 362 of the FAU 360.

Advantageously, the electro-optical device 300 of FIG. 3 provides a device in which the TIA 322 and the driver 324 are arranged on separate chips and wire bonded to the hybrid PIC 330, with the hybrid PIC 330 combining the receiver and transmitter elements onto a single chip. The architecture of the electro-optical device 300 can allow for a single FAU to be attached whilst providing optical functionality to both the receiver and transmitter circuits, namely because the transmitter and receiver elements are lithographically defined on the same PIC chip. The architecture of the electro-optical device 300 can thus provide a high level of packaging.

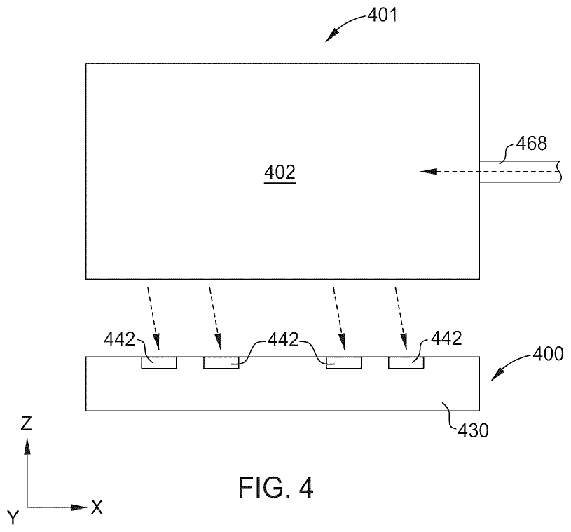

FIG. 4 is a schematic side view of an electro-optical assembly 401 having an electro-optical device 400 arranged relative to a multiplexing device 402, according to one or more aspects of the present disclosure. The electro-optical device 400 can include a hybrid PIC 430, which can be constructed in a similar manner as the other hybrid PICs disclosed herein. In this manner, the hybrid PIC 430 includes surface-illuminated photodiodes 442 associated with respective Rx channels. The hybrid PIC 430 can also include receiver electrical traces that electrically couple the surface-illuminated photodiodes 442 with a TIA of an EIC (not pictured). In addition, the hybrid PIC 430 can include a transmitter circuit having one or more transmitter channels each with a grating coupler, an optical waveguide, a modulator optically coupled with the grating coupler by way of the optical waveguide, and a transmitter electrical trace electrically coupling the modulator with a driver of the EIC. The multiplexing device 402 is external to the electro-optical device 400.

The multiplexing device 402, which can be a multiplexing/demultiplexing device, can receive an incoming optical signal by way of an optical fiber 468 and can separate the incoming optical signal into a plurality of optical signals by wavelength or bands. The separated optical signals can be directed to the electro-optical device 400 and captured by respective ones of the surface-illuminated photodiodes 442, which can convert the incoming optical signals into electrical signals, as explained previously. Advantageously, because the surface-illuminated photodiodes 442 are polarization insensitive, polarization separation functionality (e.g., provided by birefringent material) of the multiplexing device 402 can be reduced or eliminated. Thus, in one or more examples, the surface-illuminated photodiodes 442 of the electro-optical device 400 can be coupled with a multiplexing/demultiplexing device that does not separate the incoming optical signal into different polarization modes. In this regard, a higher yielding multiplexing/demultiplexing solution with increased coupling performance and lower cost can be achieved.

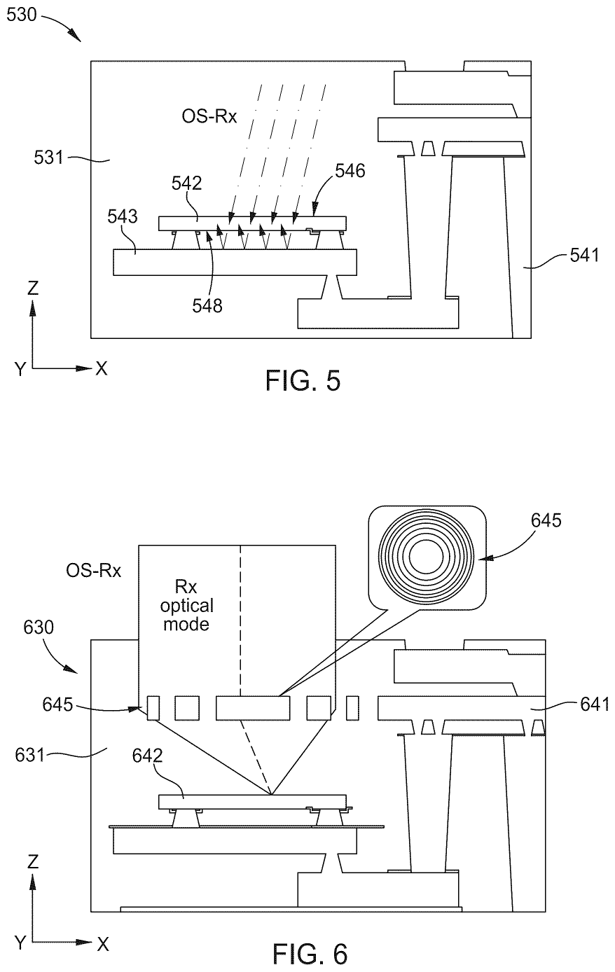

FIG. 5 is a close-up cross-sectional view of a hybrid PIC 530 that can be implemented into an electro-optical device according to one or more aspects of the present disclosure. For instance, the features of the hybrid PIC 530 can be implemented into any one of the hybrid PICs 130, 230, 330, 430 or others disclosed herein.

As depicted in FIG. 5, the hybrid PIC 530 includes, among other things, a surface-illuminated photodiode 542 embedded within a dielectric layer 531 (e.g., glass) and a plurality of metal layers 541 arranged to electrically couple the surface-illuminated photodiode 542 with a receiver electrical trace (not pictured), which can electrically couple the surface-illuminated photodiode 542 with a TIA of an EIC. The surface-illuminated photodiode 542 has a first surface 546 (e.g., a top surface) and an opposing second surface 548 (e.g., a bottom surface). Incoming optical signals OS-Rx are incident to the first surface 546 as depicted in FIG. 5. The hybrid PIC 530 also includes a reflective layer 543 arranged adjacent to the surface-illuminated photodiode 542. In this example, the reflective layer 543 is arranged directly below the surface-illuminated photodiode 542, e.g., along the Z-direction, and consequently, the reflective layer 543 faces the second surface 548 of the surface-illuminated photodiode 542. In one or more examples, the reflective layer 543 can be formed of metal, such as copper.

The incoming optical signals OS-Rx travel through the dielectric layer 531 and strike the first surface 546 of the surface-illuminated photodiode 542, causing the surface-illuminated photodiode 542 to absorb light from the incoming optical signals OS-Rx. Some of the light from the incoming optical signals OS-Rx traverses through the surface-illuminated photodiode 542 and reflects off of the reflective layer 543. The light reflected off of the reflective layer 543 is directed back toward the surface-illuminated photodiode 542 and strikes the second surface 548 of the surface-illuminated photodiode 542, causing the surface-illuminated photodiode 542 to absorb the reflected light, which can improve the responsivity of the surface-illuminated photodiode 542 or can allow for the surface-illuminated photodiode 542 to be made thinner whilst maintaining the responsivity and/or control dark current.

FIG. 6 is a close-up cross-sectional view of a hybrid PIC 630 that can be implemented into an electro-optical device according to one or more aspects of the present disclosure. For instance, the features of the hybrid PIC 630 can be implemented into any one of the hybrid PICs 130, 230, 330, 430, 530 or others disclosed herein.

As shown in FIG. 6, the hybrid PIC 630 includes, among other things, a surface-illuminated photodiode 642 embedded within a dielectric layer 631 (e.g., glass) and a plurality of metal layers 641 arranged to electrically couple the surface-illuminated photodiode 642 with a receiver electrical trace (not pictured), which can electrically couple the surface-illuminated photodiode 642 with a TIA of an EIC. The hybrid PIC 630 includes a diffractive element 645 arranged upstream of the surface-illuminated photodiode 642 along an optical path to focus incoming optical signals OS-Rx onto the surface-illuminated photodiode 642. In one or more examples, the diffractive element 645 can be Fresnel zone plates. A close-up view of diffractive element 645, shown as Fresnel zone plates, is depicted in FIG. 6. Advantageously, utilizing the diffractive element 645 to focus the incoming optical signals OS-Rx onto the surface-illuminated photodiode 642 can enable a smaller active area of the surface-illuminated photodiode 642, which increase bandwidth and/or reduce capacitance. Moreover, utilizing the diffractive element 645 to focus the incoming optical signals OS-Rx onto the surface-illuminated photodiode 642 can enable more relaxed position requirements for incoming beam alignment (e.g., by several extra microns of lateral offsets that still focus onto a center of the active area of the surface-illuminated photodiode 642).

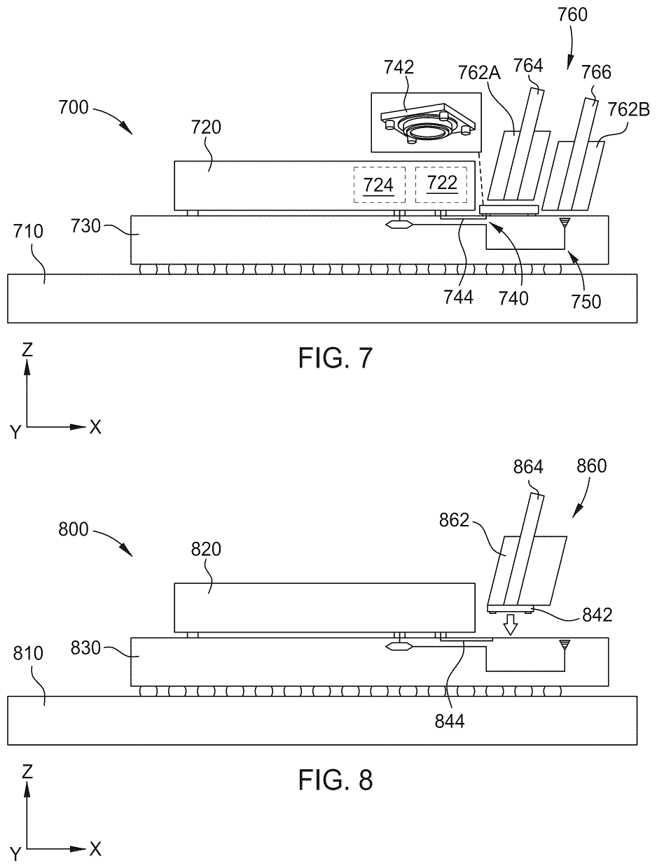

FIG. 7 is a schematic side cross-sectional view of an electro-optical device 700 according to one or more aspects of the present disclosure. As will be explained further below, the electro-optical device 700 includes a hybrid PIC that includes a receiver circuit and a transmitter circuit. For the receiver circuit, the hybrid PIC can include one or more surface-illuminated photodiodes that are flip-chip attached to a chip of the hybrid PIC (e.g., a top surface thereof). The receiver circuit can include one or more receiver channels. At least one of the receiver channels can have a surface-illuminated photodiode that is flip-chip attached. The transmitter circuit can remain fully integrated onto the hybrid PIC. Accordingly, for the example of FIG. 7, the electro-optical device 700 can be deemed an electro-optical device having a silicon interposer with integrated transceiver optical frontend.

As illustrated in FIG. 7, the electro-optical device 700 includes a substrate 710 (e.g., a PCB), an EIC 720, a hybrid PIC 730, and an FAU 760. The hybrid PIC 730 can be bonded or otherwise attached to the substrate 710, and the EIC 720 can be bonded or otherwise attached to the hybrid PIC 730. In this regard, the EIC 720 can be stacked on the hybrid PIC 730, and the hybrid PIC 730 can be stacked on the substrate 710. The EIC 720 has a TIA 722 and a driver 724, which can be located on a single chip. In at least one example, the EIC 720 can be an ASIC, e.g., for networking applications.

The hybrid PIC 730 has a receiver circuit 740 and a transmitter circuit 750 both coupled with the EIC 720. The receiver circuit 740 is coupled with the TIA 722 while the transmitter circuit 750 is coupled with the driver 724. The receiver circuit 740 has a surface-illuminated photodiode 742 arranged to directly receive incoming optical signals (e.g., from a first optical fiber 764 of the FAU 760) and to convert the incoming optical signals to electrical signals, with the electrical signals being routed to the TIA 722 by way of a receiver electrical trace 744 of the receiver circuit 740.

In the depicted example of FIG. 7, the surface-illuminated photodiode 742 is backside illuminated and flip-chip attached to a top surface of the hybrid PIC 730. In at least one example, the surface-illuminated photodiode 742 can be flip-chip attached next to the TIA 722, which can minimize the length of the receiver electrical trace 744. The receiver electrical trace 744, which can be mounted on, or embedded within, the hybrid PIC 730, electrically couples the surface-illuminated photodiode 742 with the TIA 722. With this architecture, the hybrid PIC 730 can be used as a silicon electrical interposer on the receiver side. The surface-illuminated photodiode 742 can be an annular surface-illuminated photodiode. The transmitter circuit 750 can be configured in a similar manner, e.g., as the transmitter circuit 150 of the electro-optical device 100 of FIG. 1.

Advantageously, by flip-chip attaching the surface-illuminated photodiode 742 to the hybrid PIC 730, additional flexibility in selection of the photodiode type can be provided. For instance, an indium gallium arsenide (InGaAs) photodiode, an avalanche photodiode, an active area size photodiode, a bandwidth photodiode, etc. can be selected. Polarization-insensitivity and low optical loss can also be achieved.

In one or more examples, the FAU 260 can include separate holders 762A, 762B for holding the first optical fiber 764 and a second optical fiber 766, respectively, e.g., as shown in FIG. 7. Accordingly, in such examples, the electro-optical device 700 can include independent transmitter/receiver FAU attachments. The holder 762A can be passively attached, for example. In one or more other examples, the FAU 260 can include a single holder arranged to hold the first optical fiber 764 and the second optical fiber 766, with the holder including a receiver portion arranged to hold the first optical fiber 764 and a transmitter portion arranged to hold the second optical fiber 766, with a bottom surface of the transmitter portion being arranged at a lower height than a bottom surface of the receiver portion when the FAU 760 is attached, which allows the FAU 760 to account for the height of the surface-illuminated photodiode 742 flip-chip attached to the hybrid PIC 730.

FIG. 8 is a schematic side cross-sectional view of an electro-optical device 800 according to one or more aspects of the present disclosure. As illustrated in FIG. 8, the electro-optical device 800 includes a substrate 810 (e.g., a PCB), an EIC 820, a hybrid PIC 830, and an FAU 860. The electro-optical device 800 is arranged in a similar manner as the electro-optical device 700 of FIG. 7 except as provided below. As depicted in FIG. 8, the FAU 860 includes a holder 862 that holds a first optical fiber 864. In at least one example, a surface-illuminated photodiode 842 is backside illuminated and is pre-attached to the FAU 860, such as to the bottom surface of the holder 862.

Advantageously, with the architecture of the electro-optical device 800 of FIG. 8, the surface-illuminated photodiode 842 can be pre-attached to the FAU 860, which can allow for off-package optical coupling of the first optical fiber 864 and the surface-illuminated photodiode 842, allowing flexibility in the alignment process. Moreover, the surface-illuminated photodiode 842, which is pre-attached to the FAU 860 as noted, can be attached to the top surface of the hybrid PIC 830 by ultrasonic flip-chip bonding, for example, with one of the bumps of the surface-illuminated photodiode 842 being aligned with a receiver electrical trace 844 mounted on, or embedded within, the hybrid PIC 830. Such an attachment arrangement/technique can provide for enhanced alignment tolerance. In addition, with the architecture of the electro-optical device 800, polarization-insensitivity and low optical loss can also be achieved.

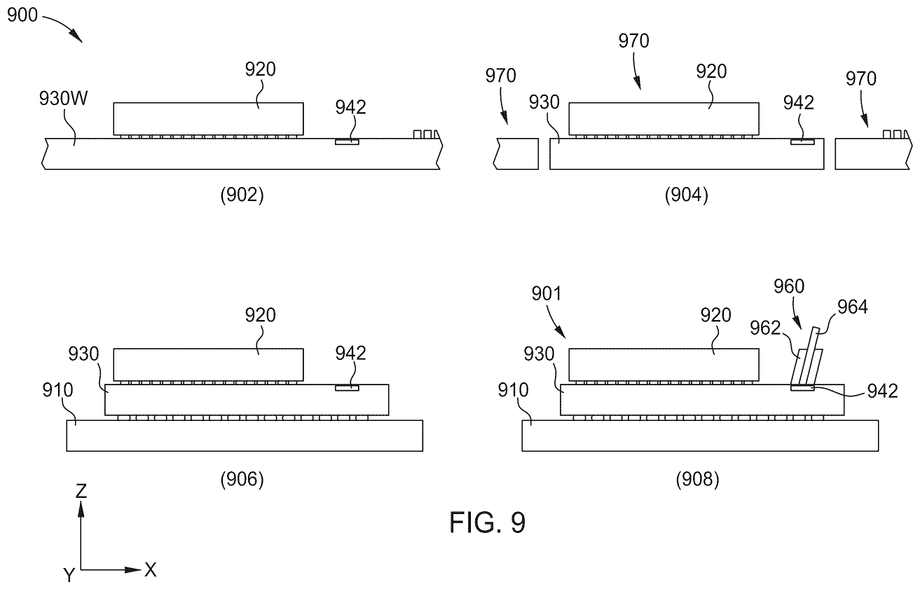

FIG. 9 provides a flow diagram for a method 900 of fabricating an electro-optical device according to one or more aspects of the present disclosure.

At 902, the method 900 can include coupling an EIC to a hybrid PIC wafer, the hybrid PIC wafer having a surface-illuminated photodiode embedded therein. For instance, as shown in FIG. 9, an EIC 920 is depicted being attached to a hybrid PIC wafer 930W having a surface-illuminated photodiode 942 embedded therein. In at least one example, the EIC 920 can be flip-chip attached to the hybrid PIC wafer 930W, e.g., with a plurality of bond pads as illustrated in FIG. 9. In one or more examples, a receiver electrical trace can be electrically coupled with the surface-illuminated photodiode 942, and when the EIC 920 is attached to the hybrid PIC wafer 930W, the receiver electrical trace can electrically couple the EIC 920 with the surface-illuminated photodiode 942. The surface-illuminated photodiode 942 and the receiver electrical trace can form a receiver channel of a receiver circuit, for example. Moreover, in at least one example, the hybrid PIC wafer 930W can include a transmitter circuit, including a grating coupler, an optical waveguide, a modulator, and a transmitter electrical trace electrically coupling the EIC 920 with the modulator. Such components can form a transmitter channel of the transmitter circuit, for example.

At 904, the method 900 can include singulating the hybrid PIC wafer to form singulated units, with at least one of the singulated units having the EIC and a hybrid PIC, which is a portion of the hybrid PIC wafer that includes the surface-illuminated photodiode. For instance, as depicted in FIG. 9, the hybrid PIC wafer 930W is shown being singulated to form singulated units, including singulated unit 970. The hybrid PIC wafer 930W can be singulated, e.g., by a dicing process. The singulated unit 970 includes the EIC 920 and a hybrid PIC 930, which is a portion of the hybrid PIC wafer 930W that includes the surface-illuminated photodiode 942. Other singulated units can be similarly constructed. In at least one example, the singulated units can include a plurality of surface-illuminated photodiodes.

At 906, the method 900 can include coupling a substrate to the hybrid PIC. For instance, as shown in FIG. 9, a substrate 910 (e.g., a PCB) can be attached to the hybrid PIC 930. In at least one example, the substrate 910 can be attached to the hybrid PIC 930 by way of a ball grid array, e.g., as illustrated in FIG. 9.

At 908, the method 900 can include attaching an FAU to the hybrid PIC, with an optical fiber of the FAU being optically coupled with the surface-illuminated photodiode. For instance, as shown in FIG. 9, an FAU 960 is depicted being attached to the hybrid PIC 930. An optical fiber 964 of the FAU 960 can be aligned with the surface-illuminated photodiode 942 so as to optically couple them together. In one or more examples, a holder 962 can hold both the optical fiber 964 associated with the receiver circuit but also an optical fiber arranged to optically couple with a grating coupler of a transmitter circuit. In this way, a combined transmitter/receiver FAU can be attached to the hybrid PIC 930. Accordingly, in accordance with the method 900, an electro-optical device 901 can be formed.

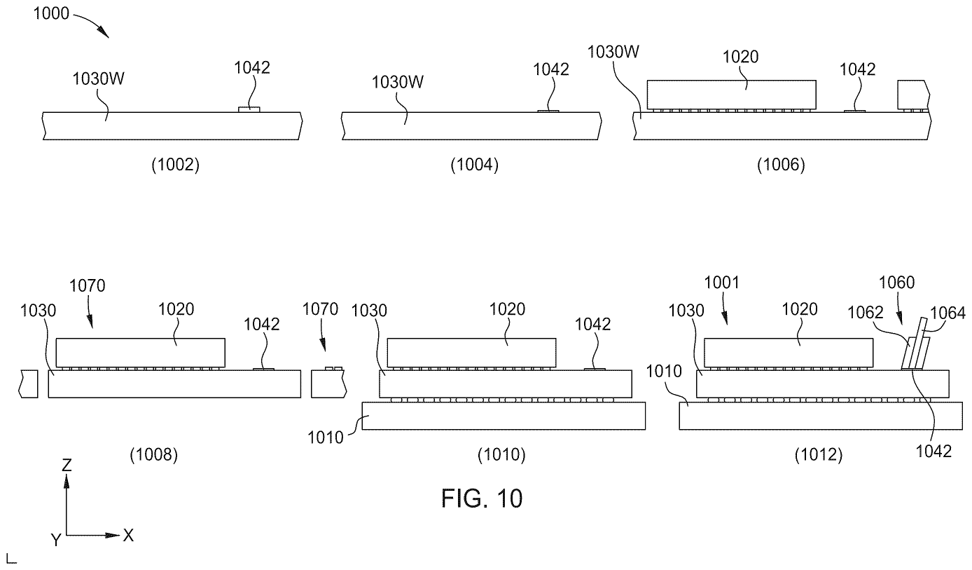

FIG. 10 provides a flow diagram for a method 1000 of fabricating an electro-optical device according to one or more aspects of the present disclosure.

At 1002, the method 1000 can include attaching a surface-illuminated photodiode to a hybrid PIC wafer, e.g., by way of direct copper bonding. For instance, as shown in FIG. 10, a surface-illuminated photodiode 1042 is depicted being attached to a hybrid PIC wafer 1030W by way of direct copper bonding. In at least one example, the surface-illuminated photodiode 1042 can be bonded face-to-face with a top surface of the hybrid PIC wafer 1030W, e.g., as illustrated in FIG. 10.

At 1004, the method 1000 can include reducing a thickness of the surface-illuminated photodiode. For instance, the surface-illuminated photodiode 1042 can be machined so as to reduce the thickness thereof, e.g., by chemical-mechanical polishing. In at least one example, the surface-illuminated photodiode 1042 can be thinned so that at least have the thickness thereof is removed.

At 1006, the method 1000 can include coupling an EIC to the hybrid PIC wafer For instance, as shown in FIG. 10, an EIC 1020 is depicted being attached to the hybrid PIC wafer 1030W having the surface-illuminated photodiode 1042. In at least one example, the EIC 1020 can be flip-chip attached to the hybrid PIC wafer 1030W, e.g., with a plurality of bond pads as illustrated in FIG. 10. In one or more examples, a receiver electrical trace can be electrically coupled with the surface-illuminated photodiode 1042, and when the EIC 1020 is attached to the hybrid PIC wafer 1030W, the receiver electrical trace can electrically couple the EIC 1020 with the surface-illuminated photodiode 1042. The surface-illuminated photodiode 1042 and the receiver electrical trace can form a receiver channel of a receiver circuit, for example. Moreover, in at least one example, the hybrid PIC wafer 1030W can include a transmitter circuit, including a grating coupler, an optical waveguide, a modulator, and a transmitter electrical trace electrically coupling the EIC 1020 with the modulator. Such components can form a transmitter channel of the transmitter circuit, for example.

At 1008, the method 1000 can include singulating the hybrid PIC wafer to form singulated units, with at least one of the singulated units having the EIC and a hybrid PIC, which is a portion of the hybrid PIC wafer that includes the surface-illuminated photodiode. For instance, as depicted in FIG. 10, the hybrid PIC wafer 1030W is shown being singulated to form singulated units, including singulated unit 1070. The hybrid PIC wafer 1030W can be singulated, e.g., by a dicing process. The singulated unit 1070 includes the EIC 1020 and a hybrid PIC 1030, which is a portion of the hybrid PIC wafer 1030W that includes the surface-illuminated photodiode 1042. Other singulated units can be similarly constructed. In at least one example, the singulated units can include a plurality of surface-illuminated photodiodes.

At 1010, the method 1000 can include coupling a substrate to the hybrid PIC. For instance, as shown in FIG. 10, a substrate 1010 (e.g., a PCB) can be attached to the hybrid PIC 1030. In at least one example, the substrate 1010 can be attached to the hybrid PIC 1030 by way of a ball grid array, e.g., as illustrated in FIG. 10.

At 1012, the method 1000 can include attaching an FAU to the hybrid PIC, with an optical fiber of the FAU being optically coupled with the surface-illuminated photodiode. For instance, as shown in FIG. 10, an FAU 1060 is depicted being attached to the surface-illuminated photodiode 1042. An optical fiber 1064 of the FAU 1060 can be aligned with the surface-illuminated photodiode 1042 so as to optically couple them together. In one or more examples, a holder 1062 of the FAU 1060 can hold both the optical fiber 1064 associated with the receiver circuit but also an optical fiber arranged to optically couple with a grating coupler of a transmitter circuit. In this way, a combined transmitter/receiver FAU can be attached. Accordingly, in accordance with the method 1000, an electro-optical device 1001 can be formed.

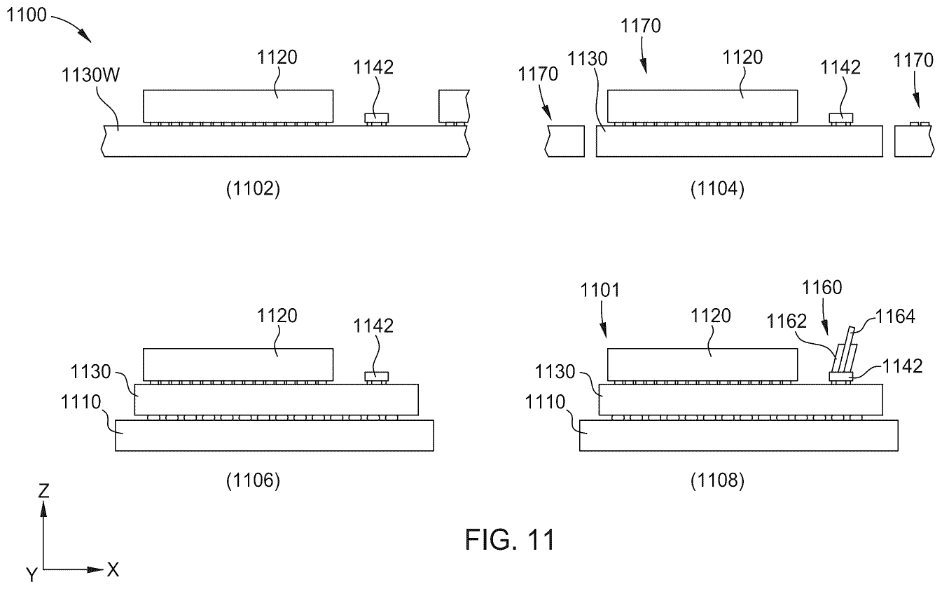

FIG. 11 provides a flow diagram for a method 1100 of fabricating an electro-optical device according to one or more aspects of the present disclosure.

At 1102, the method 1100 can include attaching both a surface-illuminated photodiode and an EIC to a hybrid PIC wafer. For instance, as shown in FIG. 11, an EIC 1120 and a surface-illuminated photodiode 1142 are depicted being attached to a hybrid PIC wafer 1130W. In at least one example, the EIC 1120 can be flip-chip attached to the hybrid PIC wafer 1130W, e.g., with a plurality of bond pads as illustrated in FIG. 11. Similarly, the surface-illuminated photodiode 1142 can be flip-chip attached to the hybrid PIC wafer 1130W. In at least one example, the surface-illuminated photodiode 1142 can be flip-chip attached to the hybrid PIC wafer 1130W as close as possible to the TIA of the EIC 1120. In one or more examples, with the EIC 1120 and the surface-illuminated photodiode 1142 attached to the hybrid PIC wafer 1130W, a receiver electrical trace embedded in the hybrid PIC wafer 1130W can electrically couple the surface-illuminated photodiode 1142 with the TIA of the EIC 1120. The surface-illuminated photodiode 1142 and the receiver electrical trace can form a receiver channel of a receiver circuit, for example. Moreover, in at least one example, the hybrid PIC wafer 1130W can include a transmitter circuit, including a grating coupler, an optical waveguide, a modulator, and a transmitter electrical trace electrically coupling the EIC 1120 with the modulator. Such components can form a transmitter channel, for example.

At 1104, the method 1100 can include singulating the hybrid PIC wafer to form singulated units, with at least one of the singulated units having the EIC and a hybrid PIC, which is a portion of the hybrid PIC wafer that includes the surface-illuminated photodiode. For instance, as depicted in FIG. 11, the hybrid PIC wafer 1130W is shown being singulated to form singulated units, including singulated unit 1170. The hybrid PIC wafer 1130W can be singulated, e.g., by a dicing process. The singulated unit 1170 includes the EIC 1120 and a hybrid PIC 1130, which is a portion of the hybrid PIC wafer 1130W that includes the surface-illuminated photodiode 1142. Other singulated units can be similarly constructed. In at least one example, the singulated units can include a plurality of surface-illuminated photodiodes.

At 1106, the method 1100 can include coupling a substrate to the hybrid PIC. For instance, as shown in FIG. 11, a substrate 1110 (e.g., a PCB) can be attached to the hybrid PIC 1130. In at least one example, the substrate 1110 can be attached to the hybrid PIC 1130 by way of a ball grid array, e.g., as illustrated in FIG. 11.

At 1108, the method 1100 can include attaching an FAU to the surface-illuminated photodiode, with an optical fiber of the FAU being optically coupled with the surface-illuminated photodiode. For instance, as shown in FIG. 11, an FAU 1160 is depicted being attached to the surface-illuminated photodiode 1142. An optical fiber 1164 of the FAU 1160 can be aligned with the surface-illuminated photodiode 1142 so as to optically couple them together. In one or more examples, a holder 1162 of the FAU 1160 can hold both the optical fiber 1164 associated with the receiver circuit but also an optical fiber arranged to optically couple with a grating coupler of a transmitter circuit. In this way, a combined transmitter/receiver FAU can be attached. Accordingly, in accordance with the method 1100, an electro-optical device 1101 can be formed.

In the current disclosure, reference is made to various embodiments. However, the scope of the present disclosure is not limited to specific described embodiments. Instead, any combination of the described features and elements, whether related to different embodiments or not, is contemplated to implement and practice contemplated embodiments. Additionally, when elements of the embodiments are described in the form of “at least one of A and B,” or “at least one of A or B,” it will be understood that embodiments including element A exclusively, including element B exclusively, and including element A and B are each contemplated. Furthermore, although some embodiments disclosed herein may achieve advantages over other possible solutions or over the prior art, whether or not a particular advantage is achieved by a given embodiment is not limiting of the scope of the present disclosure. Thus, the aspects, features, embodiments and advantages disclosed herein are merely illustrative and are not considered elements or limitations of the appended claims except where explicitly recited in a claim(s).

In view of the foregoing, the scope of the present disclosure is determined by the claims that follow.

We claim:

1. An electro-optical device, comprising:
an electronic integrated circuit (EIC) having a trans-impedance amplifier (TIA) and a driver; and
a hybrid photonic integrated circuit (PIC) having a receiver circuit and a transmitter circuit both coupled with the EIC, wherein:
the receiver circuit has a surface-illuminated photodiode arranged to directly receive incoming optical signals and to convert the incoming optical signals to electrical signals, with the electrical signals being routed to the TIA; and
the transmitter circuit comprises a modulator and a grating coupler, the modulator is arranged to convert electrical signals received from the driver to outgoing optical signals, with the outgoing optical signals being routed to the grating coupler for transmission of the outgoing optical signals.

2. The electro-optical device of claim 1, wherein the surface-illuminated photodiode and the grating coupler are arranged on the hybrid PIC so that a receiver fiber and a transmitter fiber of a fiber array unit are arranged to concurrently optically couple with the surface-illuminated photodiode and the grating coupler, respectively.

3. The electro-optical device of claim 2, wherein the surface-illuminated photodiode and the grating coupler are coplanarly arranged on the hybrid PIC.

4. The electro-optical device of claim 1, wherein the electrical signals are routed from the surface-illuminated photodiode directly to the TIA.

5. The electro-optical device of claim 1, wherein the surface-illuminated photodiode is an annular surface-illuminated photodiode.

6. The electro-optical device of claim 1, wherein the receiver circuit is polarization insensitive.

7. The electro-optical device of claim 1, wherein the surface-illuminated photodiode and a receiver electrical trace electrically coupling the surface-illuminated photodiode and the TIA form one of a plurality of receiver channels, and
wherein each one of the plurality of receiver channels has a surface-illuminated photodiode arranged to directly receive incoming optical signals and to convert the incoming optical signals to electrical signals, with the electrical signals being routed to the TIA along a receiver electrical trace.

8. The electro-optical device of claim 7, wherein the surface-illuminated photodiode of a given receiver channel of the plurality of receiver channels forms a coupling interface of the given receiver channel, wherein each one of the plurality of receiver channels has a single coupling interface.

9. The electro-optical device of claim 7, wherein the modulator and the grating coupler are components of one of a plurality of transmitter channels, and wherein each one of the plurality of transmitter channels has a modulator and a grating coupler coupled together by an optical waveguide, the modulator being arranged to convert electrical signals received from the driver to outgoing optical signals, the outgoing optical signals being routed from the modulator to the grating coupler by way of the optical waveguide for transmission of the outgoing optical signals, and
wherein the optical waveguides of the plurality of transmitter channels are each longer than the receiver electrical traces.

10. The electro-optical device of claim 9, wherein the surface-illuminated photodiode of the plurality of receiver channels are arranged closer to the EIC than the grating couplers of the plurality of transmitter channels.

11. The electro-optical device of claim 1, wherein the TIA and the driver of the EIC are formed on a single chip.

12. The electro-optical device of claim 1, wherein the TIA and the driver of the EIC are formed on separate first and second chips and are coplanarly placed next to the hybrid PIC.

13. The electro-optical device of claim 12, wherein the TIA is wire bonded to a receiver electrical trace coupled with the surface-illuminated photodiode and the driver is wire bonded to a transmitter electrical trace coupled with the modulator.

14. The electro-optical device of claim 12, wherein the surface-illuminated photodiode, the grating coupler, and the modulator are all arranged on a single chip of the hybrid PIC.

15. The electro-optical device of claim 1, wherein the surface-illuminated photodiode is coupled with a multiplexing/demultiplexing device that does not separate the incoming optical signals into different polarization modes.

16. The electro-optical device of claim 1, wherein the hybrid PIC has a reflective layer arranged adjacent the surface-illuminated photodiode so as to reflect light from the incoming optical signals that has passed through the surface-illuminated photodiode back onto the surface-illuminated photodiode.

17. The electro-optical device of claim 1, wherein the hybrid PIC has a diffractive element arranged upstream of the surface-illuminated photodiode along an optical path to focus the incoming optical signals onto the surface-illuminated photodiode.

18. The electro-optical device of claim 1, wherein the surface-illuminated photodiode is backside illuminated and flip-chip attached to the hybrid PIC, and wherein a receiver electrical trace mounted on, or embedded within, the hybrid PIC electrically couples the surface-illuminated photodiode with the TIA.

19. An electro-optical device, comprising:
a fiber array unit having a receiver fiber and a transmitter fiber; and
a hybrid photonic integrated circuit (PIC) having a receiver circuit and a transmitter circuit, wherein:
the receiver circuit has a surface-illuminated photodiode arranged to directly receive incoming optical signals from the receiver fiber and to convert the incoming optical signals to electrical signals; and
the transmitter circuit has a modulator and a grating coupler, the modulator is arranged to convert electrical signals received from an electronic integrated circuit to outgoing optical signals, with the outgoing optical signals being routed to the grating coupler for transmission of the outgoing optical signals to the transmitter fiber, and
wherein the receiver fiber and the transmitter fiber are arranged to concurrently optically couple with the surface-illuminated photodiode and the grating coupler, respectively.

20. A method, comprising:
coupling an electronic integrated circuit (EIC) to a hybrid photonic integrated circuit (PIC) wafer, the hybrid PIC wafer having a surface-illuminated photodiode embedded therein, or bonded or flip-chip attached thereto, wherein an electrical trace electrically couples the surface-illuminated photodiode with the EIC;
singulating the hybrid PIC wafer to form singulated units, with at least one of the singulated units having the EIC and a hybrid PIC, which is a portion of the hybrid PIC wafer that includes the surface-illuminated photodiode; and
attaching a fiber array unit (FAU) to the hybrid PIC so that an optical fiber of the FAU is optically coupled with the surface-illuminated photodiode, and
wherein the surface-illuminated photodiode is arranged to directly receive incoming optical signals from the optical fiber and to convert the incoming optical signals to electrical signals, with the electrical trace being arranged to route the electrical signals to the EIC.
